(19) United States
(12) Patent Application Publication
(10) Pub. No.: US 2014/0040098 A1
(43) Pub. Date: Feb. 6, 2014

(54) CONFIRMING AND RECORDING COMPLIANCE WITH MARKUP AND MARKET PRICE GUIDELINES

(71) Applicant: Bloomberg Finance L.P., New York, NY (US)

(72) Inventors: James W. Toffee, Summit, NJ (US); William J. Gartland, Fairfield, CT (US)

(21) Appl. No.: 13/958,985

(22) Filed: Aug. 5, 2013

Related U.S. Application Data
(60) Provisional application No. 61/679,162, filed on Aug. 3, 2012.

(51) Int. Cl. G06Q 40/04

(52) U.S. Cl. CPC G06Q 40/04
USPC 705/37

(57) ABSTRACT

A method includes: (a) receiving market data, in which the market data includes information relating to one or more transactions of a security; (b) obtaining, using a data processing apparatus, a contemporaneous reference value, in which the contemporaneous reference value is contemporaneous with a first transaction of the security; (c) obtaining, from the market data, a sample transaction value; (d) defining a market movement threshold value and determining whether a difference between the sample transaction value and the contemporaneous reference value is greater than the market movement threshold value; and (e) outputting to computer-based memory a result of determining whether the difference between the first sample transaction value and the first contemporaneous reference value is greater than the market movement threshold value.

### CROSS-REFERENCE TO RELATED APPLICATION

This application claims priority of U.S. Provisional Application Ser. No. 61/679,162, filed Aug. 3, 2012, which is incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Market participants that deal in debt securities generally ensure that transactions conform to certain sets of criteria. These sets of criteria can be internal guidelines or certain regulatory fair dealing guidelines. These guidelines may include requirements that a security transaction not be marked up unreasonably from the “prevailing market price.”

For example, the National Association of Securities Dealers (NASD) rule IM-2440 requires that securities not be marked up unfairly from the prevailing market price. While this is often referred to as the 5% markup rule, no fixed limit is prescribed in the rule. Rather, examiners look for patterns of behavior when determining whether a firm is meeting its fair dealings requirements. Violations of these guidelines can result in severe sanctions, yet firms that deal in debt securities regularly lack a systematic compliance methodology.

In assessing compliance, it is currently possible to compare a completed or proposed transaction to recent transactions in the same security or in other similar securities, but for many infrequently traded securities, recent transaction may not be available. Further, the prevailing market price may change drastically in a short period of time following a market shift.

NASD rule IM-2440-2 deals specifically with determining the prevailing market price for debt securities, particularly those that trade infrequently. In order to justify the dealer's price and markup on transactions, the transaction must generally be compared to some prevailing market price. Guidelines define the prevailing market price based on some hierarchy of definitions. For example, a transaction price for a similar security may be inappropriate unless no contemporaneous transaction with the actual security to be traded is available. However, regardless of the availability of transactions that are close in time to the current transaction, under most guidelines an event can be shown to have occurred that changed the prevailing market price.

### SUMMARY

This specification relates to generating and displaying compliance metrics and records for fixed income transactions.

Innovative aspects of the subject matter described in this specification can be embodied in methods that include the actions of importing market data related to one or ore financial transactions for a selected security, generating a projected reference price contemporaneous with the one or more transactions for the selected security based on one or more parameters, creating a threshold amount of price movement within the projected reference price that corresponds to a reasonable certainty of sufficient price movement, and assessing whether, based on the projected reference price and the relevant earlier transaction, there has been price movement beyond the threshold.

Embodiments can include monitoring whether a completed or proposed transaction is in compliance with a predefined set of criteria. Monitoring the completed or proposed transactions can include determining if the market has moved sufficiently to cause the dealer acquisition cost to no longer qualify as a prevailing market price. If the market has not moved sufficiently, a proposed or actual transaction price (i.e., a price of a completed transaction) is compared to the dealer acquisition cost to calculate a percentage markup. If the market has moved sufficiently, a proposed or actual transaction price is compared to a reference price for the relevant security based on the predefined set of criteria to calculate a percentage markup. If a transaction is proposed or completed beyond a threshold allowable by some set of criteria, an alert or notification can be issued, for example, to a third party. Alternatively, or in addition, a contemporaneous record of the transaction and information related to the market movement can be generated, for example, in the event of an internal or regulatory inquiry. The record can include, for example, the size of the markup applied, the prevailing market price, and/or evidence used in assessing the prevailing market price.

Some embodiments can include contextualizing trades so as to assist traders in meeting compliance obligations. Contextualizing the trades can include, for example, providing the trader with a plot of a projected reference price over a relevant time period, surrounding the projected reference price with one or more boundaries representing specified markup percentages, and displaying transactions involving the specified security over the time period specified.

Some embodiments can include creating a compliance operation for a firm to monitor some or all transactions performed by its traders. The compliance operation can include, for example: submitting completed transactions to a batch reporting facility; alerting firms, in real time, of potentially problematic trades; assessing individual transactions for compliance; generating a record for each transaction contemporaneous with the transaction in question; and highlighting records of transactions in violation of some set of criteria.

Certain embodiments include systems operable to allow traders to assess and confirm compliance with transactional guidelines. The systems may be capable of systematically presenting data that can be used to demonstrate compliance with a set of criteria or a hierarchy. Furthermore, the systems may be capable of recording observations to create a record demonstrating compliance with the relevant guidelines.

Certain embodiments include systems configured to display completed or proposed transactions in the context of the marketplace and related transactions. Within this contextualization, the systems can be further configured to display related transactions and market data that are useful for assessing conformity with guidelines with which the transactions is required to comply. Additionally, the systems can be configured to recreate a display of the contextualization so that compliance can be demonstrated at a future time. In some implementations, the relevant contextualization may incorporate only transactions of the identical security in the case of frequently traded securities. In some implementations, the relevant contextualization may also show other transactions and market movements.

Particular embodiments of the subject matter described in this specification can be implemented to realize one or more of the following advantages. In some implementations, the subject matter described herein enables determining whether, in response to market movement, a dealer acquisition cost no longer qualifies as a prevailing market price. In certain implementations, the subject matter described herein enables accounting for potential market distortion due to lack of trades.

In some implementations, the subject matter described herein allows users to monitor compliance with a set of criteria such as the NASD regulations. In particular, automated processes are provided for assessing whether the market has moved sufficiently to cause the dealer acquisition cost or some other specified transaction value to no longer qualify as a prevailing market price. Additionally, the processes allow users to assess whether the amount of the proposed or actual markup is in compliance with specified criteria, such as, for example, rule 2440. Moreover, the processes described herein provided an intuitive way for traders to contextualize the markup on any completed or proposed transaction in relation to other comparable trades.

### BRIEF DESCRIPTION OF THE DRAWINGS

FIG. 1 is a schematic representation of an exemplary system that includes an implementation of the invention.

FIG. 2 is a schematic diagram showing a method for determining a prevailing market price for compliance with markup guidelines for fixed income asset transactions.

FIG. 3 is a schematic diagram showing a method for checking and recording compliance with markup guidelines for individual fixed income asset transactions.

FIG. 4 is a schematic diagram showing an implementation of the method of FIG. 3 in a batch submission method.

FIG. 5 is a schematic diagram showing scenarios under which the method of FIG. 2 may be applied.

FIG. 6 is a schematic diagram showing a method for generating a display that can be used for contextualizing the method of FIG. 3.

FIG. 7 is a schematic diagram showing a method for selecting an appropriate transaction that can be used in the method of FIG. 2.

FIGS. 8-9 show sample displays for contextualizing the method of FIG. 2.

### DETAILED DESCRIPTION

### Definitions

Asset—The term “asset” is used in this disclosure to refer to any asset for which a particular markup guideline exists. Guidelines such as those described in the disclosure generally refer to fixed income securities and derivatives, but the methods below can also be applied to other assets in which compliance with guidelines are not obvious.

Market data—The term “market data” is used in this disclosure to refer to the broad set of financial data that will be used in making the necessary assessments.

Transaction data—The term “transaction data” is used in this disclosure to refer to the subset of the market data that contains information about transactions. The transaction data can include, for example, a transaction value and a transaction time, and it may relate to an actual completed transaction, a hypothetical transaction, or a proposed transaction.

Projected reference value—The term “projected reference value” is used in this disclosure to refer to a projected value representing the market for an asset at a specified point or period of time, and which is used by the method for determining the prevailing market price to compare a sample transaction value to the current market. Based on the result of the comparison, the method assigns either the projected reference value or the sample transaction value to be used as the prevailing market price.

Prevailing market price—The “prevailing market price” is used in this disclosure to refer to a valuation used for assessing a markup. The prevailing market price can be in terms of valuations other than price, such as yield.

Contemporaneous—The term “contemporaneous” is used in this disclosure to mean corresponding to some point or period of time. The term is used, in some implementations, with reference to data that is relevant to an asset as of a specified time at which a transaction or transactions involving the asset take place. The term is used, in some implementations, to limit data sets when the system is processing methods that assess something as of a specified time, such as when a batch process reviews completed transactions and determines compliance as of the time at which the transaction occurred.

Substantially simultaneous—The term “substantially simultaneous” is used in this disclosure to refer to events that are contemporaneous to the extent feasible within the processing limitations of the system, including any calculations necessary to obtain a specified output. For example, a projected value that is substantially simultaneous with corresponding transaction data is understood to be contemporaneous with the transaction data to the extent feasible within the processing limitations of the system, the time required to calculate the projections, the rate at which transaction data, on which projected calculations are based, is obtained by the system, and, if required, the ability of the system to render the projections to a display.

Overview

Generally, the system described below is configured to run various methods intended to monitor whether particular transactions conform to guidelines. Those guidelines can be internal guidelines designed to protect a firm from potential audits or external guidelines to ensure conformity with industry wide standards and regulatory obligations.

In order to monitor whether a particular transaction conforms to certain guidelines, the system, in some implementations, is configured to (1) determine the appropriate prevailing market price for the transactions, (2) generate one or more markup thresholds based on the prevailing market price, and (3) check the particular transaction as it relates to the one or more markup thresholds. In order to monitor whether particular transactions conform to the guidelines, the system, in some implementations, is configured to repeat the process above for each transaction within a dataset and generate contemporaneous records containing the results of the methods.

In order to determine the appropriate prevailing market price, market data related to the particular transaction can be imported, and an appropriate earlier transaction from the imported market data can be selected. A sample transaction value for the earlier transaction can be obtained, after which, a difference between the sample transaction value obtained and a projected reference value can be compared to a market movement threshold. If the difference between the sample transaction value and the projected reference value is greater than the market movement threshold, the prevailing market price can be defined as the projected reference value, and if the difference between the two values is not greater than the market movement threshold, the prevailing market price can be defined as the sample transaction value,

In order to generate one or more markup thresholds based on the prevailing market price, markup threshold criteria can be applied to the prevailing market price. The criteria may include, for example adding and/or subtracting a fixed value to the prevailing market price, or the criteria may include, for example, adding and/or subtracting a percentage to the prevailing market price. In the exemplary methods described below, there are two markup thresholds, and in the figures provided below, a single markup threshold is shown at 3% above and below the projected reference value.

In order to check whether the particular transaction conforms to the guidelines, the system can be configured to check the particular transaction against the one or more markup thresholds. The relationship between a particular transaction value and the markup thresholds can trigger actions within the system, such as warning a user regarding the particular transaction,

or preventing the transaction from occurring. The results of the assessment also can be recorded in a contemporaneous record.

In order to monitor whether multiple particular transactions conform to guidelines, the system can be configured to implement a batch method which systematically reviews all transactions within a dataset. One or more of the above operations then can be performed on each individual transaction, and contemporaneous records for all transactions can be generated. Transactions that are unique in some way can be highlighted for a user for further eview.

Example Operating Environment

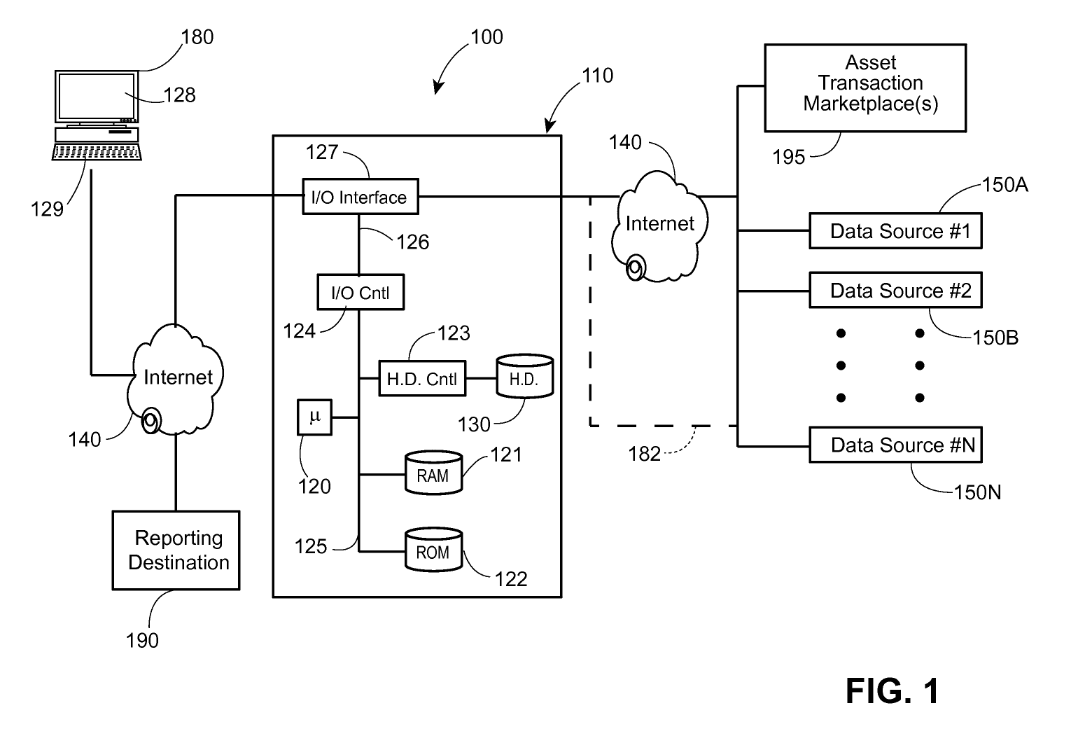

The operations described in this specification can be implemented as operations performed by a data processing apparatus on data stored on one or more computer readable storage devices or received from other sources. For example, FIG. 1 is a schematic representation of an exemplary system 100 configured to perform one or more operations described in this specification. The illustrated system 100 includes a data processing apparatus, such as a programmable processing system 110. The programmable processing system 110 is coupled via the internet 140 to a user terminal 180, a plurality of data sources 150A, 150B . . . 150N, at least one reporting destination 190, and one or more asset transaction marketplaces 195. As indicated by dashed line 182, one or more of the data sources 150A, 150B . . . 150N may be connected directly to the processing system 110.

In a typical implementation, the programmable processing system (system) 110 includes a processer 120, a random access memory (RAM) 121, a program memory 122 (for example, a writable read-only memory (ROM) such as flash ROM), a hard drive controller 123, and in input/output (I/O) controller 124 coupled by a processor (CPU) bus 125. The system 110 can be programmed by loading a program from another source (for example, from a floppy disk, a CD-ROM, or another computer).

The hard drive controller 123 is coupled to a hard disk 130 suitable for storing executable computer programs, including programs embodying aspects of the subject matter described in this specification, and data discussed in this specification.

The I/O controller 124 is coupled by means of an I/O bus 126 to an I/O interface 127. The I/O interface 127 receives and transmits data (e.g., financial data and reporting data) in analog or digital form over communication links such as a serial link, local area network, wireless link, and parallel link as well as the internet 140. In some implementations, the I/O interface 127 is connected to a user terminal 180 having a display 128 and a keyboard 129.

In one aspect, the I/O interface 127 is operable as a market data interface for receiving data and representing information related to financial data. In another aspect, the I/O interface 127 is operable as a transaction data interface for receiving data and representing a series of financial market observations over a period of time. In a typical implementation, the data can be obtained from one or more data sources (e.g., 150A, 150B . . . 150N). The data sources can include, for example, a computer terminal where data is entered manually.

The I/O interface 127 also provides an access point for a user at user terminal 180 or at a reporting destination 190 to interact with and access the data and functionality disclosed herein.

The I/O interface 127 in the illustrated implementation, also serves as an interface to a reporting destination 190, which can also be an access point for a user of the system. Thus, in a typical implementation, any desired reporting, such as reporting results, can be accomplished directly from the user terminal, for example, by accessing the processing system 110.

The I/O interface 127 in the illustrated implementation, also serves as a marketplace interface, through which a user of the system may generate transactions of fixed income securities (e.g., buying and selling assets). The user may also propose or receive proposed transactions through the I/O interface 127. The instructions for such asset transactions can be sent from the I/O interface 127 over one or more networks, such as the Internet 140 to the one or more marketplaces 195. The one or more marketplaces 195 can be, for example, a marketplace based on an order book asset listing or a marketplace based on a “Request for Quote” system. Thus, in a typical implementation, any desired transactions, requests for transactions, or receiving of requests for transactions can be accomplished by accessing the processing system 110.

The processor 120 may be adapted to calculate (or receive) and store a reference value of an asset on the series of financial market observations and for identifying a set of transaction data points associated with an asset. This information, among other information, can be stored in an electronic database, for example, in RAM module 121.

The processor 120 can also be configured to identify a subset of the market data that includes the transaction data as well as the transaction data points relevant to a specified actual or proposed transaction. The specified actual or proposed transaction may be a transaction that exists in the marketplace. The processor 120 can then be used to make certain determinations and comparisons based on the relationships identified. This information, too, can be stored in an electronic database, for example, in RAM module 121.

The display 128 and the keyboard 129 can, in a typical implementation, form an exemplary user interface. The display 128 is generally configured to present information to user that would be useful for that user. This can include, for example, alerts indicating that a user has in the past or intends to transact beyond a certain threshold or records of previous transactions in the context of a specified threshold. In some embodiments, the reporting destination 190 is coupled to a secondary user interface that can include a second display and a second keyboard.

Determining a Prevailing Market Price for Assessing Compliance with Asset Markup Guidelines

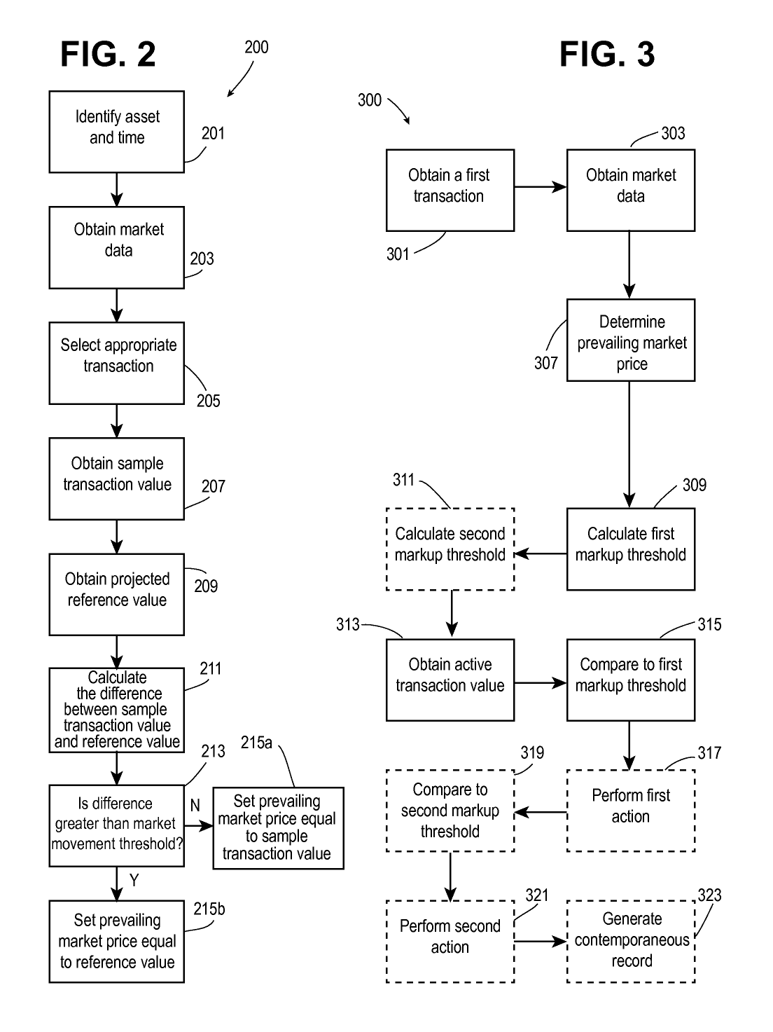

FIG. 2 is a schematic diagram showing a method for determining a prevailing market price for compliance with markup guidelines for asset transactions, in which the operations depicted may be carried out by the system 100. As shown in FIG. 2, an asset and a specified time to be analyzed are identified (201), either by the user or a different method performed by the system 100. The user may request analysis of a specified security, or, in the alternative, the system may identify the security for which a prevailing market price is determined as part of the method for assessing compliance 300 or the batch submission method 400. The identified asset corresponds to the asset for which a prevailing market price is to be determined, whereas the time corresponds to the instant or moment in time the analysis will relate to. The time may be the time at which the user requests the analysis. Alternatively, the time may be a time at which the specified security was transacted. For example, in the batch submission method 400, past transactions are assessed, and each transaction will be associated with the time at which the transaction occurred. For the purposes of this disclosure, the specified time corresponds to the current time (i.e., time concurrent with the operations of the system), unless specified otherwise.

The system then obtains (203) market data for fixed income assets relevant to the identified asset. This market data is contemporaneous with the time identified in the previous operation (201). In the alternative, the market data can exist within the system or can be loaded into the system before the asset and time are identified. The market data is then filtered to relate to a time period contemporaneous with identified time. The market data can include trades in fixed income securities reported by members of the Financial Industry Regulatory Authority (FINRA) under the Trade Reporting and Compliance Engine (TRACE) program, trades in municipal securities reported by the Municipal Securities Rulemaking Board (MSRB) under the Real-Time Transaction Reporting System (RTRS), as well as information provided to centralized recordkeeping facilities, such as Swap Data Repositories (SDR) or any other data reporting paradigm that may exist. The data can also include information related to United States Treasury Securities and assorted market observations. These observations can also include various quotes for the asset being assessed, as well as quotes for other comparable assets. Such data can be received in data feeds or it may be received by a central computer and placed in a database. Alternatively, the data may be entered manually.

An appropriate transaction from the market data then can be optionally selected (205) for use as a sample transaction corresponding to the identified asset that will be analyzed. This transaction is selected from a subset of the market data occasionally referred to herein as transaction data. This transaction can be a single transaction that is represented in the transaction data extracted from the market data already received in the previous operation (203), and can include transactions catalogued in TRACE, MSRB's RTRS, SDRs, and other data reporting paradigms for completed transactions as well as proposed transactions compiled from various sources. Such transaction data can also be received in data feeds or it may be received by a central computer and placed in a database. In some implementations, the appropriate transaction can be selected from the data feeds by the system 100 using an automated method, such as that described in FIG. 7. Alternatively, the appropriate transaction may be selected manually and related data may be entered by a user of the system.

In selecting a transaction manually, a user may provide information such as a date range, a type of transaction, a trade value, size, date, or time, and/or whether the transaction sought is an inter-dealer or dealer-customer transaction. The system can then provide the user with a set of transactions that conform to the criteria identified, and the user may select one or more transaction from those provided. If the user selects more than one transaction, the prices of the transaction can be combined, for example, by weighting averages. Alternatively, the user may simply enter a value to be used in the assessment, such as his holding cost for the asset.

The method may also identify several trades that can be used as sample transactions using a method, such as the method 700 for selecting an appropriate transaction described below. The data for the sample transaction may include any of trade value, trade size, trade date, and/or trade time.

The exemplary embodiment of the method then obtains (207) a sample transaction value from the sample transaction selected. For example, the value may be drawn from the market data received or may be entered by a user. If no sample transaction has been selected, a user may simply have entered a holding cost to be used as a sample transaction value. In some implementations, the system 100 can use a weighted average of multiple identified transactions as a sample transaction value. The transaction value can be, for example, the price or yield applied to the specified transaction.

The system 100 then obtains (209) a projected reference value in which the projected reference value is contemporaneous with the time identified in operation (201). That is to say, the projected reference value represents a projected transaction value for the identified asset and time. Thus, the projected reference value may be, in part, time-dependent. Variations in a reference value can be based on parameters such as changes in transaction values associated with other assets in the market data, trade volume of other securities in the market data, and/or transaction timing (e.g., how often an asset is exchanged) of other assets in the market data.

A projected reference value can correspond to, for example, a projected reference price or a projected reference yield for the particular asset being evaluated, or for the asset to which the sample transaction relates. Each projected reference value 209 can be calculated using information obtained from the received market data and is independent of the identified transaction. The projected reference values may be, for example, calculated based on prices and/or yields of assets that are comparable or similar to the identified asset being evaluated. For example, if the asset being analyzed is a corporate bond issued from a company in the semiconductor industry, then a reference value for a transaction associated with that bond can be calculated partially based on prices and/or yields of bonds (or other assets) issued by other entities in the semiconductor industry as well as prices and/or yields associated with other transactions in that bond.

After obtaining both a sample transaction value and a projected reference value, the system 100 calculates (211) the difference between the two values. The difference then is compared (213) to a market movement threshold. The market movement threshold corresponds to a number indicating a maximum desired difference between the sample transaction value 207, which represents the value within the marketplace at the time of the selected transaction 205, and the projected reference price 209, which represents the current state of the market. If the difference between the sample transaction value and the projected reference value is not greater than the market movement threshold, then the market is understood to have not moved substantially in the interim between the time at which the sample transaction took place and the time identified at (201). Accordingly, the sample transaction represents the best indicator of the prevailing market price from the group including the sample transaction value and the projected reference value. If, however, the difference between the sample transaction value and the reference value is greater than the market movement threshold, that result indicates that the market has moved substantially in the interim between the time at which the sample transaction occurred and the time specified by a user. Accordingly, the sample transaction no longer represents the best indicator of the prevailing market price from that group.

In some implementations, the system 100 outputs (215a or 215b) the result of the comparison and sets the value of the prevailing market price based on the result. If the difference between the sample transaction value obtained at (207) and the reference value obtained at (209) is not greater than the market movement threshold, then the prevailing market price is set (215a) equal to the sample transaction value obtained at (207). If, however, the difference between the sample transaction value obtained at (207) and the reference value obtained at (209) is greater than the market movement threshold at (213), then the prevailing market price is set (215b) equal to the reference value obtained at (209). For example, the result can be output and stored in memory and/or output to the user terminal 180 for viewing by the user. In some implementations, the output of the comparison can also be presented and/or stored in binary form to indicate, for example, whether the sample transaction value is still a viable indicator of the current market price. For example, if the difference between the sample transaction value obtained at (207) and the reference value obtained at (209) is not greater than the market movement threshold, then the binary output can be set to 1, whereas if the difference between the sample transaction value obtained at (207) and the reference value obtained at (209) is greater than the market movement threshold at (213), then the binary value can be set to 0.

Assessing Compliance of Asset Transactions with Asset Markup Guidelines

FIG. 3 is a schematic diagram showing a method for assessing and recording compliance with markup guidelines for asset transactions.

As shown in FIG. 3, an exemplary embodiment of a method for confirming and recording compliance with markup guidelines begins by obtaining (301) a first transaction. The first transaction corresponds to a record of a single transaction, and that single transaction may be an actual completed transaction, a hypothetical transaction, or a proposed transaction. The trade data may include a transaction value, such as a transaction price or yield and an asset being transacted, as well as a transaction time. For example, for proposed transactions, the transaction time may correspond to the time at which the proposed transaction is assessed, and for completed transactions, the time may correspond to the time at which the trade was performed. The trade data can be obtained using the system 100, such as through the batch submission method 400 (described below), or the trade data may be obtained from a different system, such as a system supported by one or more external marketplaces 195. The trade data would then be provided to/obtained by the system 100 using the I/O interface 127, or it may be provided directly by a user using the user terminal 180.

The system 100 then obtains (303) market data. The market data is similar in scope to that received at 203 and is obtained from similar sources. The market data is contemporaneous with a transaction time associated with the trade data.

After obtaining the trade data and the market data, the system 100 determines (305) the appropriate prevailing value to use for confirming compliance. In the exemplary embodiment, this is done by submitting the relevant data to the method for determining the prevailing market price 200. To obtain the prevailing market price, the system 100 performs the operation 200, in which the identified asset and time correspond to the asset being transacted and the time within the transaction data. The market data obtained at (203) of process 200 is the same market data as that obtained at (303) of process 300. Accordingly, step (203) of process 200 does not need to be repeated since the market data has already been obtained by the system 100. Once process 200 is completed, the result obtained at (215a) or (215b) is used to set the prevailing market price (307).

After setting (307) the prevailing market price, a first markup threshold is calculated (309). The first markup threshold is a range of values that represents a value range within a specified distance of the prevailing market price set at (307). That range of values may be the set of values between P−T¹ and P+T¹, where P is the prevailing market price and T¹ is a value used to create the first markup threshold. The value, T¹, may be defined by a user or a default value may be used. The first markup threshold may be defined in terms of a specified value or a specified percentage relative to the prevailing market price, or it can be defined by a more complex algorithm. The first markup threshold may be set relative to the prevailing market price, which can be in terms of price or yield, among other possibilities. The first markup threshold can represent some range of values outside of which an action will occur. That action can be alerting the user, a third party, or preventing a proposed trade from occurring, among other possibilities.

After creating (309) the first markup threshold, a second markup threshold is optionally created (311). The second markup threshold can be defined and calculated similarly to the first markup threshold calculated at (309) and may be used to trigger a second action, similar to the actions discussed above.

Once the relevant markup thresholds are calculated, the system 100 obtains (313) an active transaction value from the trade data. This active transaction value may correspond to the price or yield of the first transaction. The active transaction value may be represented in the same units as the prevailing market price calculated at (307). The active transaction value then is compared (315) to the first markup threshold. If the active transaction value is not within the range of values comprising the first markup threshold, the system 100 performs (317) a first action. The actions performed by the system 100 may include, for example, alerting the user (e.g., causing a pop-up window to be displayed using the user interface 180), alerting a third party (e.g., sending an e-mail alert to a client device), or preventing a transaction from occurring (e.g., blocking a trade initiated by a user). In some implementations, the system 100 can prevent a transaction from occurring pending approval from a third party (e.g., the trader's supervisor). If the active transaction value obtained at (313) is not within the first markup threshold, the system 100 may optionally compare (319) the active transaction value to the second markup threshold. If the transaction is not within the second markup threshold, the system 100 may perform (321) a second action. This second action may include, for example, alerting the user (e.g., causing a pop-up window to be displayed using the user interface 180), alerting a third party (e.g., sending an e-mail alert to a client device), or preventing a transaction from occurring (e.g., blocking a trade initiated by a user, or blocking a trade initiated by a user pending approval from a third party).

The system may then optionally generate (323) a contemporaneous record of the determination. The record may specify, for example, the actual markup applied to the prevailing market price in setting the active transaction value, the trade gain, the market gain, and the net gain.

The actual markup can be calculated using the formula G^{m}=[(T+AI^{T})−(P+AI^{P})] where G^{m} is the markup gain, T is the trade price, P is the prevailing market price, and AI is the accrued interest at the time of the trade price or at the time of the prevailing market price. The markup percentage can be calculated using the formula

$${X}^{m} = \frac{{G}^{m}}{P + {AI}^{P}}$$

where X^{m} is the markup percentage. The trade gain is calculated using the formula G^{t}=[(T+AI^{T})−(D+AI^{D})] where G^{t} is the trade gain, D is the dealer cost, and AI is the accrued interest at the time of the trade or at the time of the dealer trade. The trade gain can be expressed as a percentage using the formula

$${X}^{T} = \frac{{G}^{T}}{D + {AI}^{D}}$$

where X^{T} is the percentage of trade gain. The market gain is calculated using the formula G^{R}=[(R¹+AI¹)−(R⁰+AI⁰)] where G^{R} is the market gain, R is the reference price and the exponents indicate the values at initial time 0 and final time 1. The market gain can also be expressed as a percentage using the formula

$${X}^{R} = \frac{{G}^{R}}{{R}^{0} + {AI}^{0}}$$

where X^{R} is the percentage of market gain. Finally, the net gain can be calculated using the formula Gⁿ=[G^{T}−G^{m}] where Gⁿ is the net gain. The net gain can also be expressed as a percentage using the formula Xⁿ=X^{T}−X^{R} where Xⁿ is the percentage of net gain.

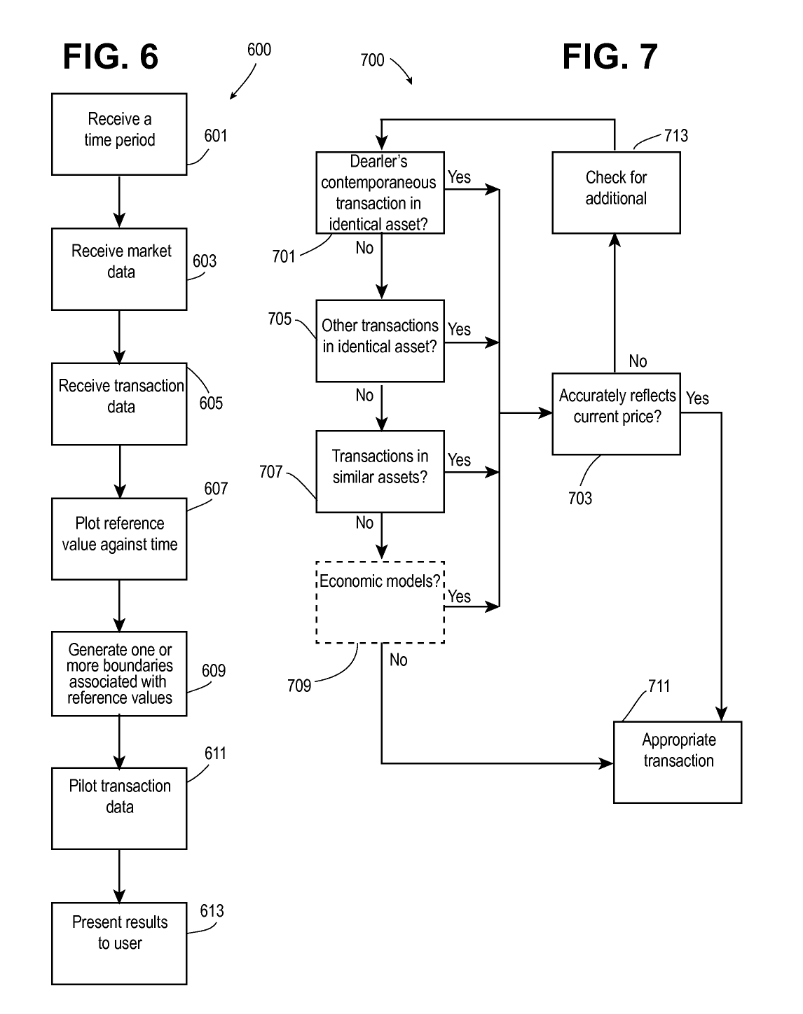

In the illustrated embodiment, certain elements of the contemporaneous record may be highlighted to indicate if the transaction was within or beyond a threshold. The contemporaneous record may further include a visual display contextualizing the transaction in the marketplace. An example of such a display is discussed below at FIGS. 6-8.

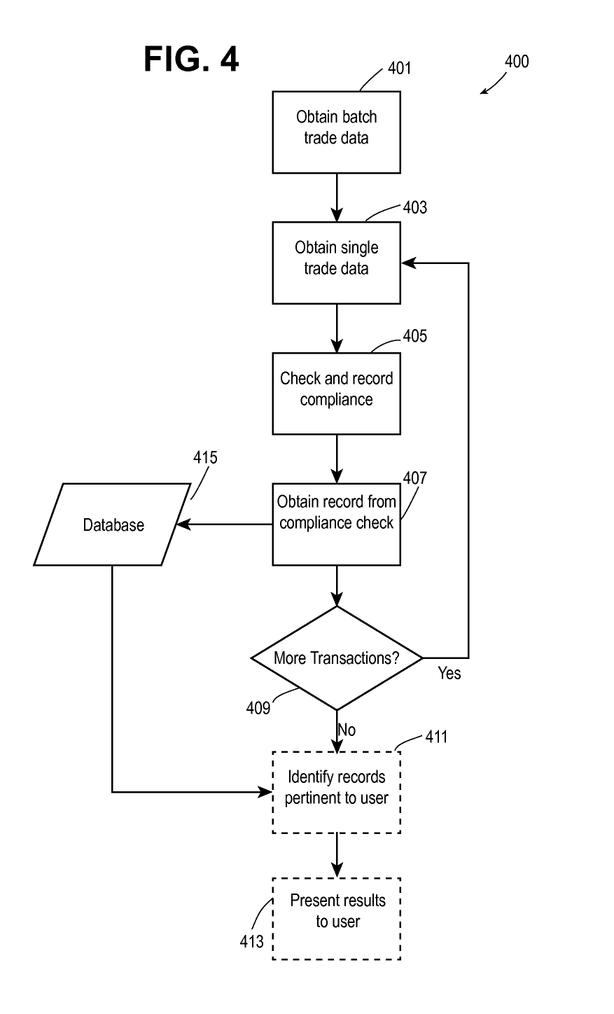

FIG. 4 is a schematic diagram showing an implementation of the method of FIG. 3 in a batch submission method 400.

In the illustrated embodiment, batch trade data is first obtained (401). This batch trade data may be stored in the system 100 or received from a user through the user nterface 180 and eontains data related to more than one trade. A user may submit all trades performed during some period at regular intervals, e.g., all trades from a given week or month. The batch trade data may be limited to data relating to trades meeting certain criteria, such as trades for specified assets or for assets with specified ratings, maturities, or other characteristics. Similarly, a user may group trades for submission based on some internal policy or algorithm.

After obtaining the batch trade data, the system 100 selects (403) data related to single trade from the batch trade data. The single trade data is a subset of the batch trade data and includes information about a single transaction. The information contained in the single trade data is identical to the first transaction obtained at (301) of process 300 and can include a value for the single transaction and a size of the single transaction as well as the date and time of the transaction. After obtaining the single trade data, the system 100 checks and records compliance (405) with a specified policy, where the policy is provided by the user or is stored in the system 100. The policy can be, for example, a firm wide compliance policy or the NASD rules. The check can be performed according to the process (300) for checking and recording compliance with markup guidelines, excluding procedure (301) since the single trade data has already been obtained at (403).

The information obtained as a result of checking compliance with the specified policy then is stored in a database 415. The system 100 then checks (409) if any more transactions remain in the batch trade data 401. The system 100 then repeats procedures 403-409 for each single transaction represented in the batch trade data 401 and stores the records obtained from the compliance check 407 in the database 415. The database 415 can be stored in memory of the system 100 (e.g., on a database server of the system 100). In some implementations, the system 100 allows a user to access the records and/or returns to the user information about the records in a report. When there are no more transactions to check, the system 100 may further process the records. In some implementations, further processing of the records includes optionally identifying (411) for the user certain pertinent records pertinent, such as records that represent trades that are particularly problematic and/or particularly safe. For example, the system 100 may access the compliance records from database 415 and optionally output a list for display at the user terminal 180, in which the list includes a selection of problematic trades and a selection of safe trades. The records stored in database 415 may be stored in memory for review at a later time period (e.g., to review in the event of an audit).

The records may be returned to the user and a list output for display at the user terminal may be sorted by various criteria. For example, a user may sort the list output for display in order of the deviation from the prevailing market price or in order of the deviation from a projected market price.

In addition to checking compliance for each individual transaction within the batch, a user may want more information about the results or about patterns in the results. For example, if a specified trader consistently trades beyond some lesser threshold, a user may want the system to alert him to that. The system may assess compliance with more complex guidelines and may analyze the resulting batch of records based on some more complex algorithm.

For example, the system may do this by specifying a first markup threshold beyond which the system simply adds to a tally. If the tally crosses a certain quantity, or a certain percentage of some group of transactions, the system may report the group of trades to be problematic, even when no single transaction has been beyond a second markup threshold specifying an alert. The group of transactions can be the group of transactions completed by a specified trader or group of traders, for example.

As another example, the system may do this by specifying certain conditions in an otherwise acceptable transaction that may warrant review either alone or when met consistently. For example, if a trader consistently completes pairs of transactions that are close in time and that include markups that are acceptable when considered in relation to the first transaction but unacceptable when considered in reference to the projected reference price, the user may want to be alerted to each transaction or pattern of transactions.

The system may assess this by creating some time period which can act as a boundary period between transactions. For example, this time period can be ten minutes. If less than ten minutes pass between transactions, the system may keep a record of the result of the transaction as assessed relative to the first transaction as the prevailing market price and separately, as assessed relative to the projected reference price as the prevailing market price. If the results of the two assessments differ, the user may want to be alerted either for each transaction or for a specified pattern of transactions.

The system may be configured to capture various other scenarios and patterns of scenarios. These patterns may be either built into the system or specified by the user.

Assessing Compliance of Asset Transactions with Asset Markup Guidelines Under Different Market Scenarios

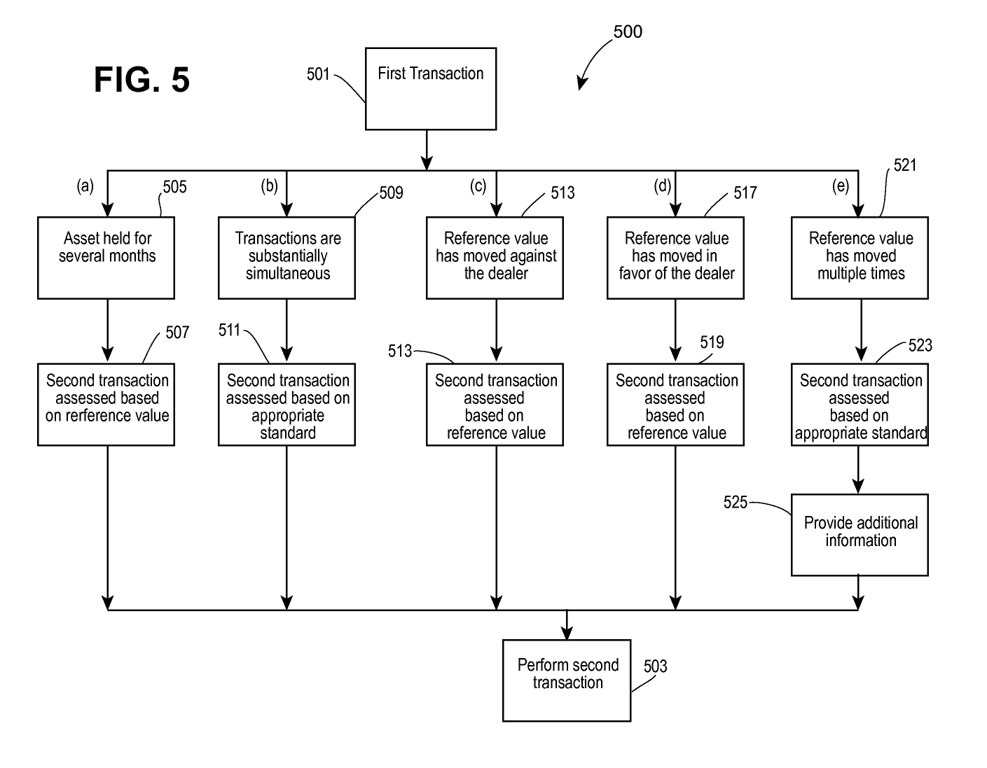

FIG. 5 is a schematic diagram showing various scenarios 500 under which the method 300 of FIG. 3 may be applied.

In the scenarios 500 illustrated in FIG. 5, five paths are shown demonstrating possible scenarios ((a)-(e)) in a trader's portfolio and in the broader marketplace in the time between a first transaction 501 and a second transaction 503. The first transaction 501 corresponds to a transaction selected by the system 100 or submitted by a user in stage (205) of the method 200 for determining a prevailing market price. If the first transaction represents the dealers own transaction in which he acquired the asset, the value of the first transaction represents the dealers holding cost, which is then used as the sample transaction value (207). The second transaction 503 corresponds to a transaction represented by the trade data obtained by the system 100 in stage (301) of the method 300 for assessing and recording compliance. The second transaction 503 can includes, for example, an actual completed transaction, a hypothetical transaction, or a proposed transaction.

The first scenario (a) relates to a dealer holding (505) an asset in inventory for a threshold amount of time (e.g., several days, weeks, or months), where the threshold represents a substantial amount of time to hold the asset. When a dealer holds an asset for a substantial amount of time, it is likely that the market will have moved significantly during the interim. If the difference between the sample transaction value represented by the first transaction 501 and the projected reference value is greater than the market movement threshold at the time of the second transaction 503, this movement is assessed by method 200 and the system 100 will therefore define the prevailing market price 307 as the reference value 209 when applying method 300. The compliance of the dealer's second transaction 503 is therefore assessed (507) based on the reference value 209.

The second scenario (b) relates to a dealer orchestrating substantially simultaneous transactions (509). That is to say, the two transactions occur within some narrow time frame. This type of pairing is common, for example, in the fixed income market, as a dealer will purchase an asset from a client in order to immediately sell it to a different dealer or vice versa. In this situation, the value of the first transaction 501 can be compared to the projected reference value (which is calculated at stage (209) of method 200) in order to determine the prevailing market price (calculated at stage (307) of method 300). The compliance of the dealer's second transaction 503 then is assessed (511) based on whether the first transaction 501 is within or outside the market movement threshold, regardless of the time that passes between the two transactions. That is, if the difference between the first ransaction value 501 and the projected value is less than or equal to the market movement threshold of the projected reference value, then the prevailing market price is defined as the value of the first transaction 501. If the difference between the first transaction value 501 and the projected value is greater than the market movement threshold, then the prevailing market price is defined as the projected reference value.

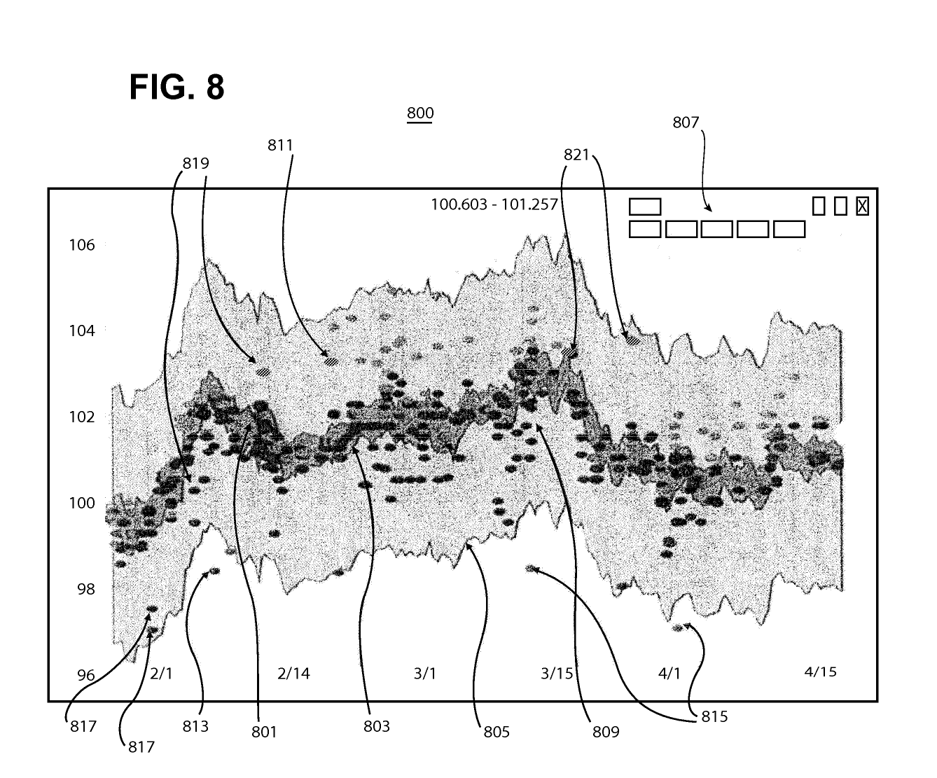

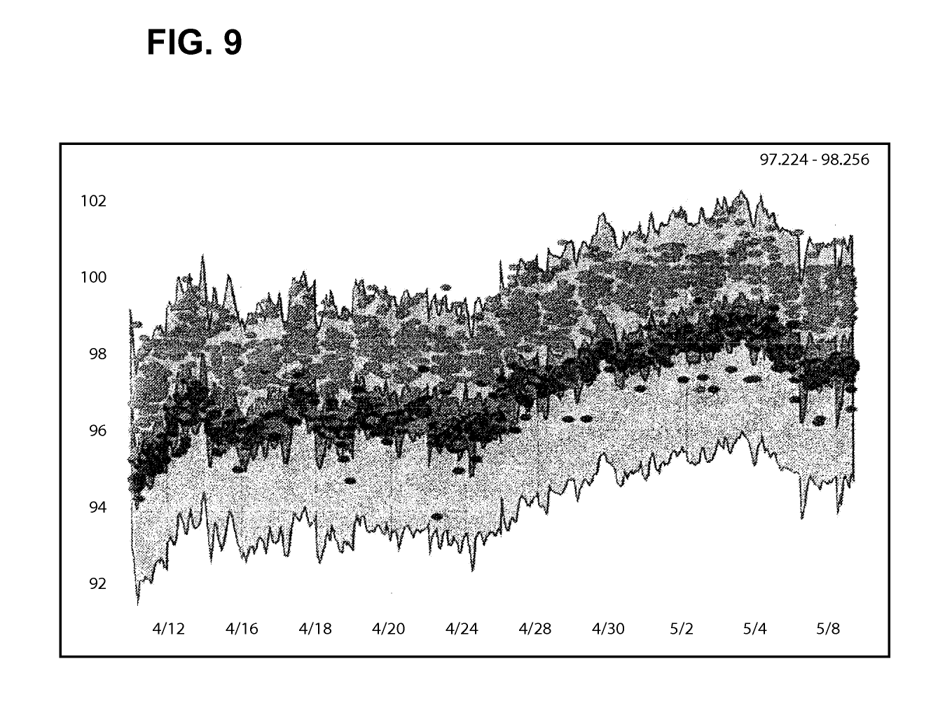

The second scenario (b) captures situations where a dealer makes a pair of transactions in order to realize an immediate gain without assessing the fairness to the client in relation to the marketplace as a whole. The markup against the first transaction 501 as well as the markup against the market as a whole may be recorded as part of the optional contemporaneous record of the transaction (generated at stage (323) of method 300). In addition, a plot illustrating the state of the transactions against the marketplace, such as those illustrated in FIG. 8-9, may be generated by the system 100 and also recorded as part of the contemporaneous record.

The third (c) and fourth (d) scenarios illustrated in FIG. 5 each relate to a dealer acting in an environment in which the market moves aggressively during the time period between the first transaction 501 and the second transaction 503. In the third scenario (c), a dealer makes a first transaction 501 and the market moves against him (513) before he completes his second transaction 503. For example, if the dealer attempts to sell an asset purchased in a first transaction 501, the value of the asset drops or if the dealer attempts to buy an asset sold in a first transaction, the value of the asset climbs. Regardless of the time that passes between the transactions, the method 200 for determining a prevailing market price can assess whether the market has moved beyond the market movement threshold (calculated at stage (213) of method 200), and the method 300 for assessing compliance will define the prevailing market price appropriately. If the market has moved beyond the market movement threshold, the second transaction 503 will be assessed (515) based on the projected reference value. If the dealer attempts to complete a second transaction 503 at a value within a markup threshold calculated relative to the first transaction 501 but not within a markup threshold calculated relative to the projected reference value 209, the method of assessing compliance 300 will compare the second transaction 503 to the first markup threshold 315, and optionally to the second markup threshold 319, and respond based on whichever value is determined by the method for determining a prevailing market price.

The fourth (d) of the scenarios illustrated 500 shows the opposite situation. In the fourth scenario (d), the dealer completes the first transaction 501 and the market moves in favor (517) of the dealer. In this situation, the dealer prefers to mark up relative to the projected reference value rather than the value of the first transaction 501. As before, even if the time that passes is relatively short, the method for determining a prevailing market price set forth in FIG. 2 can be used by the system 100 to assess whether the market has moved beyond the market movement threshold. The method for assessing compliance set forth in FIG. 3 can be used by the system 100 to define the prevailing market price appropriately. If the dealer attempts to complete a second transaction 503 at a value within a markup threshold calculated relative to the projected reference value but which appears to be marked up excessively relative to the value of the first transaction 501, the process 300 for assessing compliance 300 will compare the second transaction 503 to the first markup threshold 315, and optionally to the second markup threshold 319, and respond accordingly. If the difference between the first transaction and the projected reference value is greater than the market movement threshold 213, the second transaction 503 will be assessed based on the projected reference value (519).

In this situation, the transaction may appear improper because of the disparity in values between the first transaction 501 and the second transaction 503. The dealer responsible for the transaction therefore benefits from having a contemporaneous record of the transaction (generated at stage (323) of process 300) in the context of the marketplace illustrating his compliance with relevant guidelines.

The fifth (e) of the scenarios illustrated 500 shows a combination of the previous situations, in which multiple movements in the marketplace lead to a more complex path in the marketplace from the first transaction 501 to the second transaction 503. In this situation, the projected reference value has moved multiple times (521), and it may have moved in favor of the dealer before settling back before the second transaction 503 is proposed or completed. As before, regardless of the amount of time that passes, the method for determining a prevailing market price 200 can be used by the system 100 to assess whether he market has moved beyond a market movement threshold and assign a prevailing market price, and the method for assessing compliance 300 can be used by the system 100 to assess compliance with a markup guideline. If the dealer attempts to complete a second transaction 503 at a value that would be appropriate relative to the projected reference value but which appears to be marked up excessively relative to the value of the first transaction 501, the method of assessing compliance 300 will compare the second transaction 503 to the first markup threshold, and optionally to the second markup threshold, and respond accordingly. That is, if, at the time of the assessment, the difference between the first transaction 501 and the projected reference value is greater than the market movement threshold 213, the second transaction 503 will be assessed based on the projected reference value (523). In this situation, a user may require additional guidance in order to determine the appropriate prevailing market price, and the method can provide additional information (525). For example, the additional information can take the form of a display allowing the user to properly contextualize the transactions in the marketplace in reference to a simplified markup threshold. When the guidelines allow the user to proceed with a transaction despite the transaction being outside of a markup threshold, the user may determine that the price is appropriate based on the totality of the fluctuation shown in the display. Based on that information, the user may choose to transact despite non conformity with the guidelines.

FIG. 6 is a schematic diagram showing a method for generating a display that can be used for contextualizing the method of FIG. 3.

In the method 600 of FIG. 6, a display can be generated to help a user in contextualizing the results of the method of FIG. 3. In the illustrated embodiment, a time period over which to plot relevant data is received (601) by the system 100. For example, the time period can be based on a default time period, or the time period can be selected by a user. Once the time period is received, the system 100 receives market data (603). The market data can include trades in fixed income securities reported by members of FINRA under TRACE and MSRB under RTRS, as well as information provided to centralized recordkeeping facilities, such as SDRs or any other data reporting paradigm that may exist. The data can also include information related to United States Treasury Securities and assorted market observations. These observations can also include various quotes for the asset being assessed, as well as quotes for other comparable assets. Such data can be received in data feeds or it may be received by the system 100 and placed in a database. Alternatively, the data may be entered manually by a user operating, for example, the user interface 180.

The system 100 then receives transaction data (605) for a set of transactions that occurred during the time period 601. The transaction data may correspond to a subset of the received market data received and can include one or more of a trade price, trade size, trade date, trade time, and/or trade type. The transaction data can include data regarding a transaction being actively assessed. In the illustrated embodiment, the transactions are related to a single asset being assessed.

The projected reference value then is plotted against time (607). In the preferred embodiment, the projected reference value is a projected price or projected yield value for a specified asset that can be plotted against time. The projected reference value can be plotted, for example, as a time sequence, but it can also be plotted at fixed intervals. After the projected reference value is plotted against time, the system 100 generates (609) one or more elements associated with the projected reference value. For example, the elements can include one or more boundary elements. The boundary elements can then be superimposed on the projected reference value and can represent a bid/ask spread, as well as various markup thresholds. The markup thresholds can include, for example, the first markup threshold calculated at stage (309) of method 300 or the second markup threshold calculated at stage (311) of the procedure 300. In addition to plotting the markup thresholds based on the projected reference value plotted against time, the system 100 also can plot other markup thresholds. The other markup thresholds may correspond to, for example, market movement thresholds, such as that used in stage (213) of method 200. A market movement threshold may be based on a sample transaction selected by the system or selected by a user.

After the various thresholds are plotted in the form of one or more halos associated with the projected reference value, along with any additional thresholds plotted in relation to some other values, such as a market movement threshold, the system 100 plots (611) a set of transaction data. The set of transaction data can include the set of all transactions in the time period being assessed or it may include a subset of those transactions. The set of transactions can include a proposed or actual transaction being assessed by the user of the system.

The method for generating a display, as set forth in FIG. 6, can be used independently from the process 200 for determining a prevailing market price or the process 300 for determining compliance with markup guidelines. Alternatively, or in addition, the process for generating the display can be incorporated as part of one or more of the procedures set forth in the present disclosure. For example, a display generated according to this method may be incorporated into a contemporaneous record generated at stage (323) of method 300.

FIG. 7 is a schematic diagram showing a method for selecting an appropriate transaction that can be used in the method 200 for determining a prevailing market price.

In order to properly assess compliance with guidelines, the method 200 for determining a prevailing market price requires the selection of an appropriate transaction 205. A user may identify or propose the appropriate transactions or the method for selecting the appropriate transaction can be performed automatically by the system 100. FIG. 7 provides an example embodiment of an automated method in which an appropriate transaction can be selected for determining a prevailing market price.

In the illustrated embodiment, the system 100 first assesses transactions by the same dealer within a specified dataset in identical assets contemporaneous with a transaction being assessed (701). An identical asset is one having identical identifying information that would therefore have an identical valuation. This can be, for example, a bond with an identical CUSIP. Contemporaneous in this context can be determined based on some time threshold that determines the time proximity between two transactions. The time threshold can be provided by a user or can be based on defaults within the system 100. If there are no contemporaneous transactions in an identical asset by the same dealer, the system 100 determines whether there are other transactions in identical assets contemporaneous with a transaction being assessed (705). These other transactions need not be transactions by the dealer attempting to complete the transaction being assessed.

When there are one or more contemporaneous transactions in an identical asset, any contemporaneous transactions are assessed to determine if they accurately reflects the current price (703). In the illustrative embodiment, this assessment can be done in several ways. For example, the assessment can entail determining if the transaction falls within the market movement threshold (calculated at stage (213) of method 200). If the system determines that the transaction does accurately reflect the current price, the system 100 labels the transaction as the appropriate transaction (711). If, on the other hand, the transaction does not fall within the market movement threshold, the system 100 checks (713) for additional transactions.

When there are other transactions of an identical asset 705, those assets are assessed to determine if they accurately reflect the current price (703). This assessment can be made in the same way as the assessment related to the dealer's transaction 701. If there are no other transactions in an identical asset and/or the other transactions are determined to not accurately reflect the current price, the system 100 determines whether there are transactions in similar assets 707. Similarity of assets can be assessed based on various criteria, including the technological field of the issuer of the security, the maturity bucket or rating of the asset, or various other aspects of the asset. For example, after processing transactions in identical assets, the system may then process transactions in assets from the same security issuer, followed by transactions in assets from the same maturity bucket and so on. When using an asset that is not identical, the system may adjust the value based on some formula to make the value comparable to the asset in the transaction being assessed.

Whenever system 100 uncovers a potentially relevant transaction (e.g., in stages (701), (705), and (707)), that transaction is assessed to determine if it accurately reflects the current price (703). If no potentially relevant transactions remain, an economic model may optionally be used (709) to determine an appropriate value for a transaction. When an economic model is used to generate or determine an appropriate transaction value, the system 100 may skip the process 200 of determining a prevailing market price entirely. The value generated by the economic model may then be used as the prevailing market price when determining compliance with an asset markup guideline such as the procedure followed in FIG. 3.

FIGS. 8-9 show example screen shots of displays that may be generated by the method 600 set forth in FIG. 6 and that may be used for contextualizing the method 300 set forth in FIG. 3.

The screen shots in FIGS. 8 and 9 also provide context to the various scenarios 500 presented in FIG. 5. For example, the screen shot of FIG. 8 is an example display obtained using the process 600 applied to a specific security issued by an entity (e.g., Rite Aid Corporation). A price estimation 801 can be shown as a colored line (e.g., a green line) and is surrounded by two upper boundaries and two lower boundaries. The boundary representing the bid/ask spread estimation 803 and the boundary representing the first markup threshold 805 can be shown in shades of different colors and each represents a different range of values. The spaces encompassed by the boundaries can also be shaded in different colors. In the embodiment shown in FIG. 8, the first markup threshold 805 represents a markup of 3% relative to the price estimation 801. In the illustrated embodiment, a time period 807 selected by a user in the embodiment is 3 months. Different categories of transactions may be presented as different colors. For example, dealer transactions 809 can be shown as yellow circles. Customer buys 811 can be shown in a different color (e.g., light blue circles) from other types of transactions. Similarly, customer sells 813 can be shown as a different color (e.g., red circles) from other transactions. Similarly, dealer to dealer transactions can be shown as a different color from other types of transactions. Any transaction that falls outside of the first markup threshold 805, such as transactions 815, may trigger an alert.

Referencing the scenarios 500 in FIG. 5, the market movements between a first transaction 501 and a second transaction 503 can now be illustrated. The pair of transactions marked 817 appear to be a typical pair of substantially simultaneous transactions. In this scenario, using the dealer transaction cost as the prevailing market price for the customer sell would yield a modest markup—in this case about one half of a point. However, when viewed in the context of the price estimation 801, the markup is close to 3 points, placing it very close to the first markup threshold 805. In this scenario, the system 100 will assess the transaction value of the first transaction in the pair of transactions 817 to determine if the dealer transaction cost is within the market movement threshold when compared to the price estimation 801. Additionally, the figure provided can provide additional context for a user. For example, the figure may provide a broader picture of the marketplace allowing the user to assess his transaction independently of any alert triggered.

Other scenarios can be seen in FIG. 8 as well. In order to illustrate, we will assume that specified transactions are actually pairs of transactions. Assuming that the two transactions 819 are a pair of transactions, we see a situation in which the projected reference value 801 has moved in favor of the dealer subsequent to completion of the first transaction in the pair 819. In this situation, compliance is assessed based on the projected reference value 801, allowing the dealer to transact at a value that would otherwise appear to be a substantial markup. Similarly, assuming the two transactions 821 are a pair of transactions, we see that the market moved dramatically against the dealer (projected reference price dropped) in the time between the two transactions 821. In this case, the dealer's markup is modest when compared to the earlier transaction of the pair 821, but is much more substantial when compared to the reference value 801.

FIG. 9 shows the method applied to a more actively traded asset. The illustrated embodiment shows an asset in which the projected reference value may have moved multiple times after any given transaction if the asset is held for more than approximately a day. In this situation, the display provides additional information that can be used to supplement the methods assessment regarding compliance with relevant guidelines. Although a proposed transaction may be beyond a threshold, the user may want to assess the likelihood of the projected reference value, and by extension the markup threshold, moving substantially in the future. A user may therefore choose to ignore a warning provided in reference to an asset that moves substantially on a regular basis.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be indicated in the numbered paragraphs near the end of this disclosure, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described in the numbered paragraphs near the end of this disclosure as such, one or more features from such a combination can in some cases be excised from the combination, and the combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following numbered paragraphs. For example, though the subject matter of the present disclosure relates to fixed income and OTC derivative markets, the techniques disclosed herein may also be applied to other types of markets, as appropriate. In some cases, the actions recited in the numbered paragraphs can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer based method comprising:
(a) receiving market data, wherein the market data comprises information relating to one or more transactions of a security;
(b) obtaining, using a data processing apparatus, a contemporaneous reference value, wherein the contemporaneous reference value is contemporaneous with a first transaction of the security;
(c) obtaining, from the market data, a sample transaction value;
(d) defining a market movement threshold value and determining whether a difference between the sample transaction value and the contemporaneous reference value is greater than the market movement threshold value; and
(e) outputting to computer-based memory a result of determining whether the difference between the first sample transaction value and the first contemporaneous reference value is greater than the market movement threshold value.

2. The computer based method of claim 1 wherein the first transaction comprises a prospective transaction of the security or a completed transaction of the security.

3. The computer based method of claim 1 further comprising (f) defining a first prevailing market price,
wherein the first prevailing market price is the sample transaction value when the difference between the sample transaction value and the contemporaneous reference value is not greater than the market movement threshold value, and
wherein the first prevailing market price is the contemporaneous reference value when the difference between the sample transaction value and the contemporaneous reference value is greater than the market movement threshold value.

4. The computer based method of claim 3 further comprising:
(g) calculating a first markup threshold related to the first prevailing market price;
(h) determining whether a magnitude of the difference between a value of the first transaction and the first prevailing market price is greater than a magnitude of the difference between the first markup threshold and the first prevailing market price; and
(i) outputting to the computer-based memory a result of determining whether the magnitude of the difference between the value of the first transaction and the first prevailing market price is greater than the magnitude of the difference between the first markup threshold and the first prevailing market price.

5. The computer based method of claim 4, further comprising, repeating (b)-(i) for a second transaction from the market data in place of the first transaction.

6. The computer based method of claim 5, further comprising, repeating (b)-(i) for at least one additional transaction from the market data in place of the second transaction, wherein each of the at least one additional transactions are processed consecutively.

7. The computer based method of claim 4, further comprising:
calculating a second markup threshold related to the first prevailing market price;
(k) determining whether a magnitude of the difference between a value of the first transaction and the first prevailing market price is greater than the magnitude of the difference between the second markup threshold and the first prevailing market price; and
(l) outputting to the computer-based memory a result of (k).

8. The computer based method of claim 4, further comprising:
outputting an alert when the magnitude of the difference between the value of the first transaction and the first prevailing market price is greater than the magnitude of the difference between the first markup threshold and the first prevailing market price.

9. The computer based method of claim 7, further comprising:
preventing a proposed transaction from occurring when the magnitude of the difference between the value of the first transaction and the first prevailing market price is greater than the magnitude of the difference between the second markup threshold and the first prevailing market price.

10. The computer based method of claim 4, further comprising:
generating a contemporaneous record of the result of determining whether the magnitude of the difference between the value of the first transaction and the first prevailing market price is greater than the magnitude of the difference between the first markup threshold and the first prevailing market price.

11. The computer based method of claim 5, further comprising:
generating a contemporaneous record for any transaction that is a completed transaction.

12. The computer based method of claim 11, further comprising:
identifying one or more contemporaneous records of transactions where the magnitude of the difference between the value of the first transaction and the first prevailing market price is greater than the magnitude of the difference between the first markup threshold and the first prevailing market price.

13. The computer based method of claim 1, further comprising:
determining, based on the market data, one or more of the following:
whether a transaction contemporaneous with the first transaction in the security represents an acceptable sample transaction value;
whether a transaction that is non-contemporaneous with the first transaction in the security represents an acceptable sample transaction value; and
whether a transaction in an asset different from the security represents an acceptable sample transaction value.

14. A computer based method comprising:
(a) receiving market data, wherein the market data comprises information relating to one or more transactions of a security;
(b) obtaining, using a data processing apparatus, at least one contemporaneous reference value, wherein the at least one contemporaneous reference value is contemporaneous with a portion of the market data;
(c) calculating a first markup threshold related to the at least one contemporaneous reference value; and
(d) outputting to a user terminal a result of calculating the first markup threshold related to the at least one contemporaneous reference value
wherein a display at the user terminal comprises a plot of the at least one contemporaneous reference value overlaid with the first markup threshold; and
wherein the first markup threshold is displayed as a boundary above and below a prevailing market price, wherein the region within the boundaries corresponds to an acceptable transaction region and the regions outside the boundaries correspond to regions of potentially unacceptable transactions.

15. The computer based method of claim 14 wherein the first markup threshold represents either an addition of a constant to or a linear transformation of the at least one contemporaneous reference value.

16. The computer based method of claim 14 wherein the display at the user terminal further comprises a scatter plot of transactions contained in the market data.

17. The computer based method of claim 14 wherein the display at the user terminal further comprises one or more highlighted transactions, wherein the one or more highlighted transactions are actual or proposed transactions for which compliance with a markup standard is being assessed.

18. The computer based method of claim 14 further comprising:
calculating a second markup threshold related to the at least one contemporaneous reference value;
wherein the display at the user terminal further comprises a plot of the second markup threshold overlaid with the at least one contemporaneous reference value and the first markup threshold.

19. A computer system comprising:
one or more user devices; and
one or more computers operable to interact via a computer network with the one or more user devices,
wherein the one or more computers comprise a compliance engine configured to:
(a) receive market data, wherein the market data comprises information relating to one or more transactions of a security;
(b) obtain a contemporaneous reference value, wherein the contemporaneous reference value is contemporaneous with a first transaction of the security;
(c) obtain a sample transaction value;
(d) define a market movement threshold value and determine whether a difference between a the sample transaction value and the contemporaneous reference value is greater than the market movement threshold value; and
(e) output a result of the determination.

20. The computer system of claim 19 wherein the first transaction comprises a prospective transaction of the security or a completed transaction of the security.

21. The computer system of claim 19 wherein the compliance engine is further configured to:
(f) define a first prevailing market price,
wherein the first prevailing market price is the sample transaction value when the difference between the sample transaction value and the contemporaneous reference value is not greater than the market movement threshold value, and
wherein the first prevailing market price is the contemporaneous reference value when the difference between the sample transaction value and the contemporaneous reference value is greater than the market movement threshold value.

22. The computer system of claim 21 wherein the compliance engine is further configured to:
(g) calculate a first markup threshold related to the first prevailing market price;
(h) determine whether a magnitude of the difference between a value of the first transaction and the first prevailing market price is greater than a magnitude of the difference between the first markup threshold and the first prevailing market price; and
(i) output a result of (h).

23. The computer system of claim 22 wherein the compliance engine is further configured to repeat (b)-(i) for a second transaction from the market data in place of the first transaction.

24. The computer system of claim 23 wherein the compliance engine is further configured to repeat (b)-(i) for at least one additional transaction from the market data in place of the second transaction, wherein each of the at least one additional transactions are processed consecutively.

25. The computer system of claim 22 wherein the compliance engine is further configured to:
calculate a second markup threshold related to the first prevailing market price; determine whether a magnitude of the difference between a value of the first transaction and the first prevailing market price is greater than a magnitude of the difference between the second markup threshold and the first prevailing market price; and
outputting the result.

26. The computer system of claim 22 wherein the compliance engine is further configured to output an alert when the magnitude of the difference between a value of the first transaction and the first prevailing market price is greater than a magnitude of the difference between the first markup threshold and the first prevailing market price.

27. The computer system of claim 25 wherein the compliance engine is further configured to prevent a proposed transaction from occurring when the magnitude of the difference between the value of the first transaction and the first prevailing market price is greater than the magnitude of the difference between the second markup threshold and the first prevailing market price.

28. The computer system of claim 22 wherein the compliance engine is further configured to generate a contemporaneous record of the result of determining whether the magnitude of the difference between the value of the first transaction and the first prevailing market price is greater than the magnitude of the difference between the first markup threshold and the first prevailing market price.

29. The computer system of claim 23 wherein the compliance engine is further configured to generate a contemporaneous record for any transaction that is a completed transaction.

30. The computer system of claim 29 wherein the compliance engine is further configured to identify one or more contemporaneous records of transactions wherein the magnitude of the difference between the value of the first transaction and the first prevailing market price is greater than the magnitude of the difference between the first markup threshold and the first prevailing market price;

31. The computer system of claim 19 wherein the computers further comprise a selection engine configured to determine, based on the market data, one or more of the following:
whether a transaction contemporaneous with the first transaction in the security represents an acceptable sample transaction value;
whether a transaction that is non-contemporaneous with the first transaction in the security represents an acceptable sample transaction value; and
whether a transaction in an asset different from the security represents an acceptable sample transaction value.

32. A computer system comprising:
one or more user devices; and
one or more computers operable to interact via a computer network with the one or more user devices,
wherein the one or more computers comprise a compliance engine configured to:
(a) receive market data, wherein the market data comprises information relating to one or more transactions of a security;
(b) obtain, using a data processing apparatus, at least one contemporaneous reference value, wherein the at least one contemporaneous reference value is contemporaneous with a portion of the market data; and
(c) calculating a first markup threshold related to the at least one contemporaneous reference value;
and wherein the one or more computers further comprise a display engine configured to output to a user terminal a result of calculating the first markup threshold related to the at least one contemporaneous reference value,
wherein a display at the user terminal comprises a plot of the at least one contemporaneous reference value overlaid with the first markup threshold, and wherein the first markup threshold is displayed as a boundary above and below a prevailing market price, wherein the region within the boundaries corresponds to an acceptable transaction region and the regions outside the boundaries correspond to regions of potentially unacceptable transactions.

33. The computer system of claim 32 wherein the first markup threshold represents either an addition of a constant to or a linear transformation of the at least one contemporaneous reference value.

34. The computer system of claim 32 wherein the display engine is further configured to display a scatter plot of transactions contained in the market data.

35. The computer system of claim 32 wherein the display engine is further configured to display one or more highlighted transactions, wherein the one or more highlighted transactions are actual or proposed transactions for which compliance with a markup standard is being assessed.

36. The computer system of claim 32 wherein the compliance engine is further configured to calculate a second markup threshold related to the at least one contemporaneous reference value and wherein the display engine is further configured to display a plot of the second markup threshold overlaid with the at least one contemporaneous reference value and the first markup threshold.
